(19) United States
(12) Patent Application Publication
(10) Pub. No.: US 2017/0086008 A1
(43) Pub. Date: Mar. 23, 2017

(54) Rendering Virtual Audio Sources Using Loudspeaker Map Deformation

(71) Applicant: Dolby Laboratories Licensing Corporation, San Francisco, CA (US)

(72) Inventor: Charles Q. Robinson, Piedmont, CA (US)

(73) Assignee: Dolby Laboratories Licensing Corporation, San Francisco, CA (US)

(21) Appl. No.: 15/271,979

(22) Filed: Sep. 21, 2016

Related U.S. Application Data
(60) Provisional application No. 62/221,536, filed on Sep. 21, 2015.

(30) Foreign Application Priority Data
Oct. 29, 2015 (EP) 15192091.5

(51) Int. Cl. H04S 7/00; G10L 19/20

(52) U.S. Cl. CPC H04S 7/308; G10L 19/20; H04S 2400/11; H04S 2400/13

(57) ABSTRACT

A method of rendering an audio program by generating one or more loudspeaker channel feeds based on the dynamic trajectory of each audio object in the audio program, wherein the parameters of the dynamic trajectory may be included explicitly in the audio program, or may be derived from the instantaneous location of audio objects at two or more points in time. Embodiments include rendering audio by defining a nominal loudspeaker map of loudspeakers used for playback of the audio program, determining a trajectory of an auditory source corresponding to one or more audio objects through 3D space, generating loudspeaker signals feeding the loudspeakers based on the one or more audio object trajectories, and rendering the one or more audio objects based on object location to match the trajectory of the auditory source as perceived by a listener.

### CROSS-REFERENCE TO RELATED APPLICATION(S)

This application claims priority to U.S. Provisional Patent Application No. 62/221,536, filed Sep. 21, 2015, and European Patent Application No. 15192091,5, filed Oct. 29, 2015, both of which are hereby incorporated by reference in their entireties.

### FIELD OF THE INVENTION

One or more implementations relate generally to spatial audio rendering, and more particularly to creating the perception of sound at a virtual auditory source location.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

There are an increasing number of applications in which it is desirable to create an acoustic sound field that creates the impression of a particular sound scene for listeners within the sound field. One example is the sounds created as part of a cinema presentation using newer developed formats that extend the sound field beyond standard 5.1 or 7.1 surround sound systems. The sound field may include elements that are a reproduction of a recorded sound event using one or more microphones. The microphone placement and orientation can be used to capture spatial relationships within an existing sound field. In other cases, an auditory source may be recorded or synthesized as a discrete signal without accompanying location information. In this latter case, location information can be imparted by an audio mixer using a pan control (panner) to specify a desired auditory source location. The audio signal can then be rendered to individual loudspeakers to create the intended auditory impression. A simple example is a two-channel panner that assigns an audio signal to two loudspeakers so as to create the impression of an auditory source somewhere at or between the loudspeakers. the following, the term “sound” refers to the physical attributes of acoustic vibration, while “auditory” refers to the perception of sound by a listener. Thus, the term “auditory event” may refer to generally a perception of sound rather than a physical phenomenon, such as the sense of sound itself.

At present there are several existing rendering methods that generate loudspeaker signals from an input signal to create the desired auditory event at a particular source location. In general, a renderer determines a set of gains, such as one gain value for each loudspeaker output, that is applied to the input signal to generate the associated output loudspeaker signal. The gain value is typically positive, but can be negative (e.g., Ambisonics) or even complex (e.g., amplitude and delay panning, Wavefield Synthesis) Known existing audio renderers determine the set of gain values based on the desired, instantaneous auditory source location. Such present systems are competent to recreate static auditory events, i.e., auditory events that emanate from a non-moving, static source in 3D space. However, these systems do not always satisfactorily recreate moving or dynamic auditory events.

To generate a sense of motion through acoustics, the desired source location is time-varying. Analog systems (e.g., pan pots) can provide continuous location updates; and digital panners can provide discrete time and location updates. The renderer may then apply gain smoothing to avoid discontinuities or clicks such as might occur if the gains are changed abruptly in a digital, discrete-time panning and rendering system.

With existing, instantaneous location renderers, the loudspeaker gains are determined based on the instantaneous location of the desired auditory source location. The loudspeaker gains may be based on the relative location of the desired auditory source and the available loudspeakers, the signal level or loudness of the auditory source, or the capabilities of the individual loudspeakers. In many cases, the renderer includes a database describing the location, and capabilities of each loudspeaker. In many cases the loudspeaker gains are controlled such that the signal power is preserved, and loudspeaker(s) that are closest to the desired instantaneous auditory location are usually assigned larger gains than loudspeaker(s) that are further away. This type of system does not take into account the trajectory of a moving auditory source, so that the selected loudspeaker may be fine for an instantaneous location of the source, but not for the future location of the source. For example if the trajectory of the source is front-to-back rather than left-to-right, it may be better to bias the front and rear loudspeakers to play the sound rather than the side loudspeakers, even though the instantaneous location along the trajectory may favor the side loudspeakers.

It is therefore advantageous to provide a method for accommodating the trajectory of a dynamic auditory source in 3D space to determine the most appropriate loudspeakers for gain control so that the motion of the sound is accurately played back with minimal distortion or rendering discontinuities.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions. Dolby, Atmos, Dolby Digital Plus, Dolby TrueHD, DD+, and Dolby Pulse are trademarks of Dolby Laboratories.

### SUMMARY OF EMBODIMENTS

Embodiments are directed to a method of rendering an audio program by generating one or more loudspeaker channel feeds based on the dynamic trajectory of each audio object in the audio program, wherein the parameters of the dynamic trajectory may be included explicitly in the audio program, or may be derived from the instantaneous location of audio objects at two or more points in time. In this context, an audio program may be accompanied by picture, and may be a complete work intended to be viewed in its entirety (e.g. a movie soundtrack), or may be a portion of the complete work.

Embodiments are further directed to a method of rendering an audio program by defining a nominal loudspeaker map of loudspeakers used for playback in a listening environment, determining a trajectory of an auditory source corresponding to each audio object through 3D space, and deforming the loudspeaker map to create an updated loudspeaker map based on the audio object trajectory to playback audio to match the trajectory of the auditory source as perceived by a listener in the listening environment. The map deformation results in different gains being applied to the loudspeaker feeds. Depending on configuration and in a general case, the loudspeakers may in the listening environment, outside the listening environment or placed behind or within acoustically transparent scrims, screens, baffles, and other structures. Similarly, the auditory location may be within or outside of the listening environment, that is, sounds could be perceived to come from outside of the room or behind the viewing screen.

Embodiments are further directed to a system for rendering an audio program, comprising a first component collecting or deriving dynamic trajectory parameters of each audio object in the audio program, wherein the parameters of the dynamic trajectory may be included explicitly in the audio program or may be derived from the instantaneous location of audio objects at two or more points in time, a second component deforming a loudspeaker map comprising locations of loudspeakers based on the audio object trajectory parameters; and a third component deriving one or more loudspeaker channel feeds based on the instantaneous audio object location, and the corresponding deformed loudspeaker map associated with each audio object.

Embodiments are yet further directed to systems and articles of manufacture that perform or embody processing commands that perform or implement the above-described method acts.

### INCORPORATION BY REFERENCE

Each publication, patent, and/or patent application mentioned in this specification is herein incorporated by reference in its entirety to the same extent as if each individual publication and/or patent application was specifically and individually indicated to be incorporated by reference.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 illustrates an example loudspeaker placement in a surround system that provides height loudspeakers for playback of audio objects in 3D space.

FIG. 2 illustrates an audio system that generates and renders trajectory-based audio content, under some embodiments.

FIG. 3 illustrates object audio rendering within a traditional, channel-based audio program distribution system, under some embodiments.

FIG. 4 is a flowchart that illustrates a process of rendering audio content using source trajectory information to deform a loudspeaker map, under some embodiments.

FIG. 5 illustrates an example trajectory of an audio object as it moves through a listening environment, under an embodiment.

### DETAILED DESCRIPTION

Systems and methods are described for rendering audio streams to loudspeakers to produce a sound field that creates the perception of a sound at a particular location, the auditory source location, and that accurately reproduces the sound as it moves along a trajectory. This provides an improvement over existing solutions for situations where the intended auditory source location changes with time. In an embodiment, the degree to which each loudspeaker is used to generate the sound field is determined at least in part by the velocity of the auditory source location. Aspects of the one or more embodiments described herein may be implemented in an audio or audio-visual system that processes source audio information in a rendering/encoding system for transmission to a decoding/playback system, wherein both the rendering and playback systems include one or more computers or processing devices executing software instructions. Any of the described embodiments may be used alone or together with one another in any combination. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address all of these deficiencies.

For purposes of the present description, the following terms have the associated meanings: the term “channel” means an audio signal plus metadata in which the position is explicitly or implicitly coded as a channel identifier, e.g.., left-front or right-top surround; “channel-based audio” is audio formatted for playback through a pre-defined set of loudspeaker zones with associated nominal locations, e.g.,5.1, 7.1, and so on; the term “object” or “object-based audio” means one or more audio channels with a parametric source description, such as apparent source position (e.g., 3D coordinates), apparent source width, etc.; “immersive audio” means channel-based and/or object-based audio signals plus metadata that renders the audio signals based on the playback environment using an audio stream plus metadata in which the position is coded as a 3D position in space; and “listening environment” means any open, partially enclosed, or fully enclosed area, such as a room that can be used for playback of audio content alone or with video or other content, and can be embodied in a home, cinema, theater, auditorium, studio, game console, and the like.

Further terms in the following description and in relation to one or more of the Figures have the associated definition, unless stated otherwise: “sound field” means the physical acoustic pressure waves in a space that are perceived as sound; “sound scene” means auditory environment, natural, captured, or created; “virtual sound” means an auditory event in which the apparent auditory source does not correspond with a physical auditory source, such as a “virtual center” created by playing the same signal from a left and right loudspeaker; “render” means conversion of input audio streams and descriptive data (metadata) to streams intended for playback over a specific loudspeaker configuration, where the metadata can include sound location, size, and other descriptive of control information; “panner” means a control device used to indicate intended auditory source location within an sound scene; “panning laws” means the algorithms used to generate per-loudspeaker gains based on auditory source location; and “loudspeaker map” means the set of locations of the available reproduction loudspeakers.

### Immersive Audio Format and System

In an embodiment, the rendering system is implemented as part of an audio system that is configured to work with a sound format and processing system that may be referred to as an “immersive audio system” (and which may be referred to as a “spatial audio system,” “hybrid audio system,” or “adaptive audio system” in other related documents). Such a system is based on an audio format and rendering technology to allow enhanced audience immersion, greater artistic control, and system flexibility and scalability. An overall immersive audio system generally comprises an audio encoding, distribution, and decoding system configured to generate one or more bitstreams containing both conventional channel-based audio elements and audio object coding elements (object-based audio). Such a combined approach provides greater coding efficiency and rendering flexibility compared to either channel-based or object-based approaches taken separately.

An example implementation of an immersive audio system and associated audio format is the Dolby® Atmos® platform. Such a system incorporates a height (up/down) dimension that may be implemented as a 9.1 surround system, or similar surround sound configurations. Such a height-based system may be designated by different nomenclature where height loudspeakers are differentiated from floor loudspeakers through an x.y.z designation where x is the number of floor loudspeakers, y is the number of subwoofers, and z is the number of height loudspeakers. Thus, a 9.1 system may be called a 5.1.4 system comprising a 5.1 system with 4 height loudspeakers.

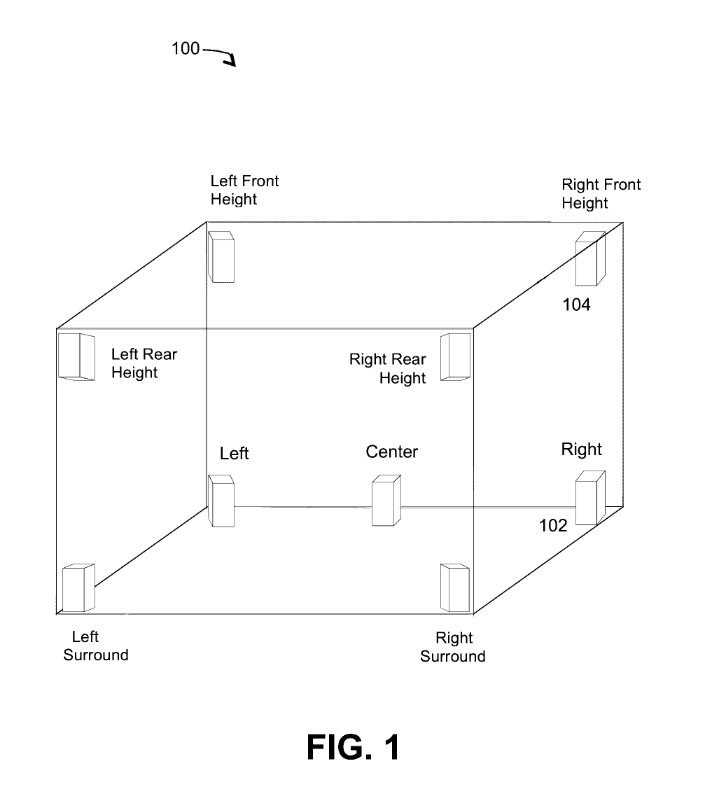

FIG. 1 illustrates the loudspeaker placement in a present surround system (e.g., 5.1.4 surround) that provides height loudspeakers for playback of height channels. The loudspeaker configuration of system 100 is composed of five loudspeakers 102 in the floor plane and four loudspeakers 104 in the height plane. In general, these loudspeakers may be used to produce sound that is designed to emanate from any position more or less accurately within the room. Predefined loudspeaker configurations, such as those shown in FIG. 1, can naturally limit the ability to accurately represent the position of a given auditory source. For example, an auditory source cannot be panned further left than the left loudspeaker itself. This applies to every loudspeaker, therefore forming a one-dimensional (e.g., left-right), two-dimensional (e.g., front-back), or three-dimensional (e.g., left-right, front-back, up-down) geometric shape, in which the mix is constrained. Various different loudspeaker configurations and types may be used in such a loudspeaker configuration. For example, certain enhanced audio systems may use loudspeakers in a 9.1, 11.1, 13.1, 19.4, or other configuration, such as those designated by the x.y.z configuration. The loudspeaker types may include full range direct loudspeakers, loudspeaker arrays, surround loudspeakers, subwoofers, tweeters, and other types of loudspeakers.

Audio objects can be considered groups of auditory events that may be perceived to emanate from a particular physical location or locations in the listening environment. Such objects can be static (i.e., stationary) or dynamic (i.e., moving). Audio objects are controlled by metadata that defines the position of the sound at a given point in time, along with other functions When objects are played back, they are rendered according to the positional metadata using the loudspeakers that are present, rather than necessarily being output to a predefined physical channel.

The immersive audio system is configured to support audio beds in addition to audio objects, where beds are effectively channel-based sub-mixes or stems. These can be delivered for final playback (rendering) either individually, or combined into a single bed, depending on the intent of the content creator. These beds can be created in different channel-based configurations such as 5.1, 7.1, and 9.1, and arrays that include overhead loudspeakers, such as shown in FIG. 1.

For an immersive audio mix, a playback system can be configured to render and playback audio content that is generated through one or more capture, pre-processing, authoring and coding components that encode the input audio as a digital bitstream. An immersive audio component may be used to automatically generate appropriate metadata through analysis of input audio by examining factors such as source separation and content type. For example, positional metadata may he derived from a multi-channel recording through an analysis of the relative levels of correlated input between channel pairs. Detection of content type, such as speech or music, may be achieved, for example, by feature extraction and classification. Certain authoring tools allow the authoring of audio programs by optimizing the input and codification of the sound engineer's creative intent allowing him to create the final audio mix once that is optimized for playback in practically any playback environment. This can be accomplished through the use of audio objects and positional data that is associated and encoded with the original audio content. Once the immersive audio content has been authored and coded in the appropriate codec devices, it is decoded and rendered for playback through loudspeakers, such as shown in FIG. 1.

### Trajectory-Based Audio Rendering System

Many audio programs may feature audio objects that are fixed in space, such as when certain instruments are tied to specific locations in a sound stage. For other audio/visual (e.g., TV, cinema, game) content, however, audio objects are dynamic in that they are associated with objects that move through space, such as cars, planes, birds, etc. Rendering and playback systems mimic or recreate this movement of sound associated with a moving object by sending the audio signal to different loudspeakers in the listening environment so that perceived auditory source location matches the desired location of the object. In general, the frame of reference for the trajectory of the moving object could be the listener, the listening environment itself, or any location within the listening environment.

Embodiments are directed to generating loudspeaker signals (loudspeaker feeds) for audio objects that are situated and move through 3D space. The audio objects comprise program content may be provided in various different formats including cinema, TV streaming audio, live broadcast (and sound), UGC (user generated content), games and music. Traditional surround sound (and even stereo) is distributed in the form of channel signals (i.e., loudspeaker feeds) where each audio track delivered is intended to be played over a specific loudspeaker (or loudspeaker array) at a nominal location in the listening environment. Object-based audio comprising an audio program that is distributed in the form of a “scene description” consists of audio signals and their location properties. For streaming audio the program may be received and played back while being delivered.

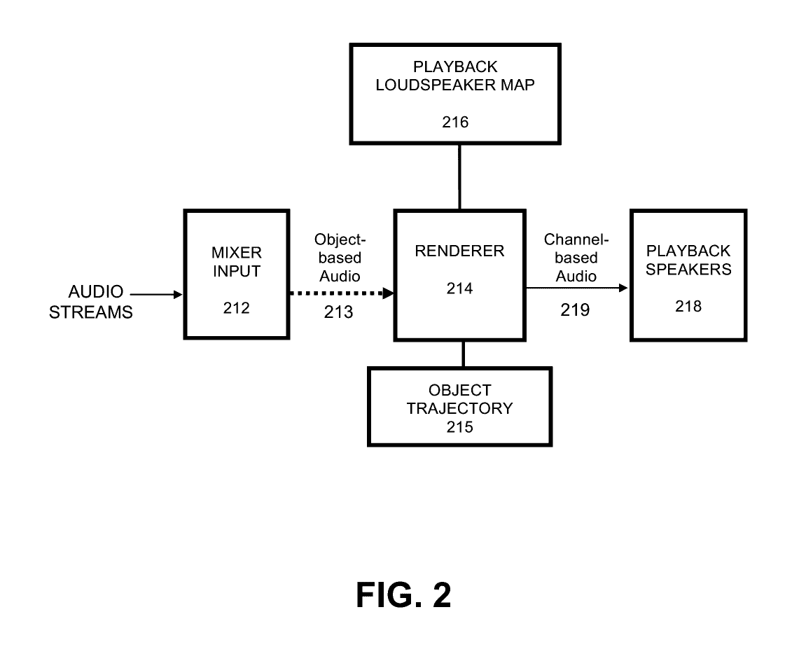

FIG. 2 illustrates an audio system that generates and renders trajectory-based audio content, under some embodiments. As shown in FIG. 2, in immersive audio system includes renderer 214 that converts the object-based scene description into channel signals. With object-based audio distribution, the renderer operates in the listening environment, and combines the audio scene description and the room description (loudspeaker configuration) to compute channel signals. In the system of FIG. 2, audio content is created (i.e., authored or produced) and encoded for transmission 213 to a playback environment. For an embodiment in which the audio content is cinema sound, the creation environment may include a cinema content authoring station or component and a cinema content encoder that encodes, conditions or otherwise processes the authored content for transmission to the playback environment. The cinema content authoring station may comprise certain cinema authoring tools that allow a producer to create and/or capture audio/visual (AV) content comprising both sound and video content. This may be used in conjunction with an audio source and/or authoring tools to create audio content, or an interface that receives pre-produced audio content. The audio content may include monophonic, stereo, channel-based or object-based sound. The sound content may be analog or digital and may include or incorporate any type of audio data such as music, dialog, noise, ambience, effects, and the like. For audio content, audio signals in the form of digital audio bitstreams are provided to a mix engineer, or other content author who provides their input, 212, that includes appropriate gains to the audio components. The mixer uses mixing tools that can comprise standard mixers, consoles, software tools, and the like.

The authored content generated by component 212 represents the audio program to be transmitted over link 213. The audio program is generally prepared for transmission using a content encoder. In general the audio is also combined with other parts of the program that may include associated video and subtitles (e.g., digital cinema). The link 213 may comprise a direct connection, physical media, short or long-distance network link, Internet connection, wireless transmission link, or any other appropriate transmission link for transmitting the digital A/V program data.

The playback environment typically comprises a movie theatre or similar venue for playback of a movie and associated audio (cinema content) to an audience, but any room or environment is possible. The encoded program content transmitted over link 213 is received and decoded from the transmission format. Renderer 214 takes in the audio program and renders the audio based on a map of the local playback loudspeaker configuration 216 for playback through loudspeakers 218 in the listening environment. The renderer outputs channel-based audio 219 that comprises loudspeaker feeds to the individual playback loudspeakers 218. The overall playback stage may include one or more amplifier, buffer, or sound processing components that amplify and process the audio for playback through loudspeakers. The loudspeakers typically comprise an array of loudspeakers, such as a surround-sound array or immersive audio loudspeaker array, such as shown in FIG. 1. The rendering component or renderer 214 may comprise any number of appropriate sub-components, such as D/A (digital to analog) converters, translators, codecs, interfaces, amplifiers, filters, sound processors, and so on.

The description of the arrangement of loudspeakers in the listening environment with respect to the physical location of each loudspeaker relative to the other loudspeakers and the audio boundaries (wall/floor/ceiling) of the room represents a loudspeaker map. For the example of FIG. 1, a representative loudspeaker map would show eight loudspeakers located at each of the corners of the cube comprising the room (sound scene) 100 and a center loudspeaker located on the bottom center location of one of the four walls. As can be appreciated, any number of loudspeaker maps may be configured and used depending on the configuration of the sound scene and the number and type of loudspeakers that are available.

In an embodiment in which the program content comprises immersive audio, the renderer 214 converts the object-based scene description into channel signals. With object-based audio distribution, the renderer operates in the listening environment, and combines the audio scene description and the room description (loudspeaker map) to compute channel signals. A similar process is followed during program authoring. In particular, the authoring process involves capturing the input of the mix engineer using the mixing tool, such as by turning pan pots, or moving a joystick, and then converting the output to loudspeaker feeds using a renderer. In this case, the transmission link 413 is a direct connection with little or no encoding or decoding, the loudspeaker map 216 describes the playback equipment in the authoring environment.

For the embodiment of FIG. 2, prior to playback, the audio content passes through several key phases, such as pre-processing and authoring tools, translation tools (i.e., translation of immersive audio content for cinema to consumer content distribution applications), specific immersive audio packaging/bit-stream encoding (which captures audio essence data as well as additional metadata and audio reproduction information), distribution encoding using existing or new codecs (e.g., DD+, TrueHD, Dolby Pulse) for efficient distribution through various consumer audio channels, transmission through the relevant consumer distribution channels (e.g., streaming, broadcast, disc, mobile, Internet, etc.). A dynamic rendering component may be used to reproduce and convey the immersive audio user experience defined by the content creator that provides the benefits of the immersive or spatial audio experience. The rendering component may be configured to render audio for a wide variety of cinema and/or consumer listening environments, and the rendering technique that is applied can be optimized depending on the end-point device. For example, home theater systems and soundbars may have 2, 3, 5, 7 or even 9 separate loudspeakers in various locations. The immersive audio content includes or is associated with metadata that dictates how the audio is rendered for playback on specific endpoint devices and listening environments. For channel-based audio, metadata encodes sound position as a channel identifier, where the audio is formatted for playback through a pre-defined set of loudspeaker zones with associated nominal surround-sound locations, e.g., 5.1, 7.1, and so on; and for object-based audio, the metadata encodes the audio channels with a parametric source description, such as apparent source position (e.g., 3D coordinates), apparent source width, and other similar location relevant parameters.

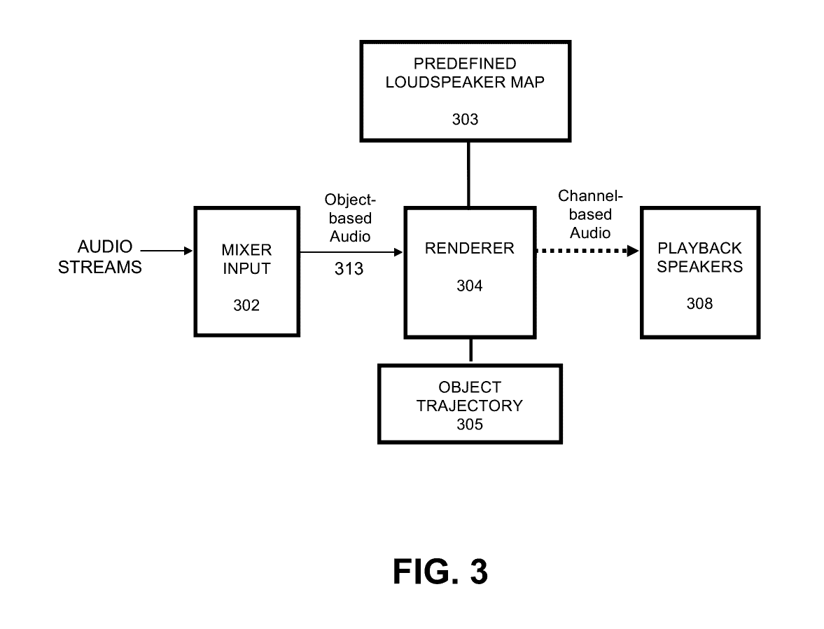

FIG. 3 illustrates object audio rendering within a traditional, channel-based audio program distribution system, under an embodiment. For channel-based audio distribution, the audio streams feed the mixer input 302 to generate object-based audio, which is input to renderer 304, which in turn generates channel-based audio in a pre-defined format defined by a loudspeaker map 303 that is distributed over link 313 for playback in the playback environment 308. In the case of channel-based audio distribution, the mixer input includes location data, and is converted directly to loudspeaker feeds (e.g. in an analog mixing console), or saved in a data file (digital console or software tool e.g. Pro Tools), and then rendered to loudspeaker feeds.

As shown in FIGS. 2 and 3, the system includes an object trajectory processing component that is part of the rendering process in either or both of the object- and channel-based rendering schemes; component 305 is part of renderer 304 in FIG. 3 and component 215 is part of renderer 214 in FIG. 2. Using the object trajectory information generates loudspeaker feeds based on the auditory source (audio object) trajectory, where the trajectory description includes current instantaneous location as well as information on how the location changes with time. The location change information is used to deform the loudspeaker map, which is then used to generate loudspeaker feeds for each of the loudspeakers in the loudspeaker map so that the best or most optimal audio signals are derived in accordance with the trajectory.

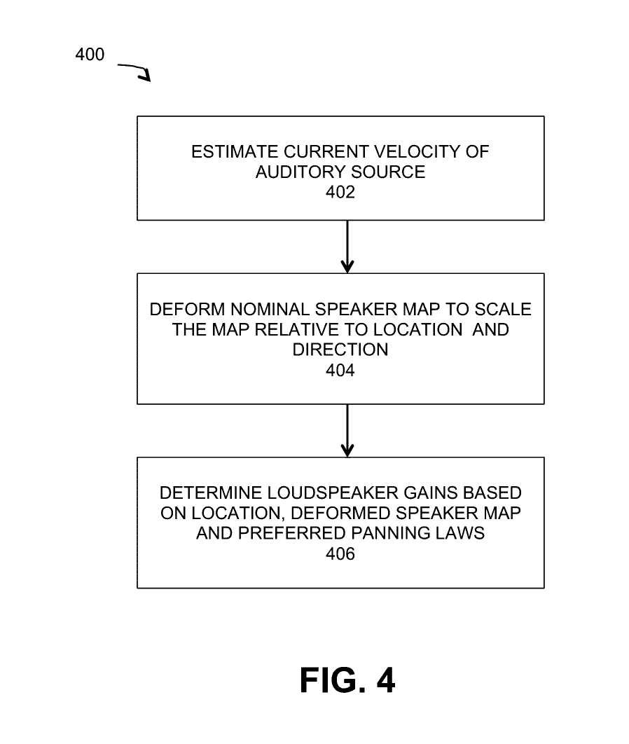

FIG. 4 is a flowchart that illustrates a process of rendering audio content using source trajectory information to deform a loudspeaker map, under some embodiments. The process 400 starts by estimating the current velocity of the desired audio object based on past, current, and future auditory source locations, 402. It then deforms the nominal loudspeaker map such that the map is scaled relative to the source location in the direction of the estimated source velocity, with the magnitude of the scaling based on the speed of the source location, 404. The location-based renderer then determines the loudspeaker gains based on source location, deformed loudspeaker map, and preferred panning laws, 406.

With respect to the step 402 of estimating the current velocity, at a given point in time, for each auditory source to be rendered, the process estimates the velocity based on previous, current and/or future auditory source locations. The velocity comprises one or both of speed and direction of the auditory source. The trajectory may thus comprise a velocity as well as a change in velocity of the audio object, such as a change in speed (slowing down or speeding up) or a change in direction of the audio object. The trajectory of an audio object thus represents higher-order position information of the audio object as manifested as the change instantaneous location of the apparent auditory source of the object over time.

The derivation of future information may depend on the type of content comprising the audio program. If the content is cinema content, typically the whole program file is provided to the renderer. In this case future information is derived simply by looking ahead in the file by an appropriate amount of time, e.g., 1 second ahead, 1/10 second ahead, and so on.) In the case of streaming content or instantaneously generated content in which the entire file is not available, a buffer and delay scheme may he utilized in which playback is delayed by an appropriate amount of time (e.g., 1 second or 1/10 second, etc.) This delay provides a look-ahead capability that allows for derivation future location. In some cases, if future auditory source locations are used, algorithmic latency must be accounted for as part of the system design, in some systems, the audio program to be rendered may include velocity as part of the sound scene description, in which case velocity need not be computed,

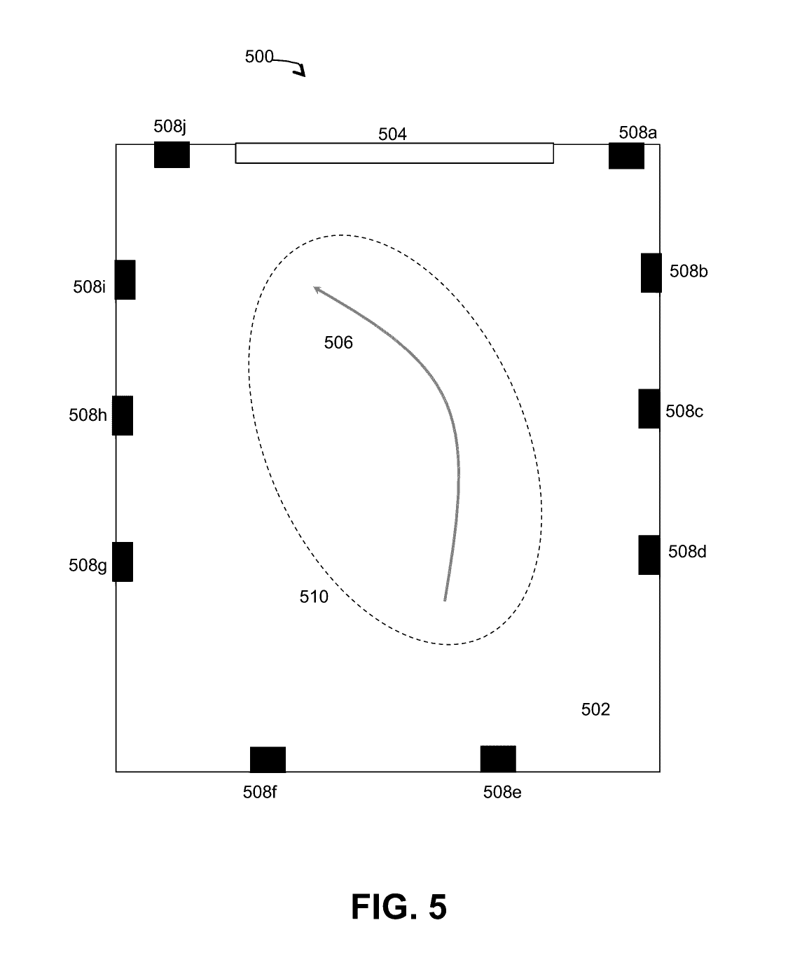

With respect to the step of deforming the nominal loudspeaker map, 404, at a given point in time, for each auditory source to be rendered, the process modifies the nominal loudspeaker map based on the object velocity. The nominal loudspeaker map represents an initial layout of loudspeakers (such as shown in FIG. 1) and may or may not reflect the true loudspeaker locations due to approximations in measurements or due to deliberate deformations applied previously. In one embodiment, the deformation is an affine scaling of the nominal loudspeaker map, with the direction of the scaling determined by the current auditory source direction of motion, and the degree of scaling based on the speed of the audio object. The scaling is a contraction such that loudspeakers along the source direction vector move closer to the auditory source, while loudspeakers located in a direction from the auditory source that is perpendicular to the source direction vector are not affected. In alternative embodiments, the scaling is alternatively or additionally determined by the acceleration of the auditory source, the variance of the direction of the auditory source, or past and future values of the auditory source velocity. FIG. 5 illustrates an example trajectory of an audio object as it moves through a listening environment, under an embodiment. As shown in diagram 500, listening environment 502, which may represent a cinema, home theater or any other environment comprises a closed area having a screen 504 on a front wall and a number of loudspeakers 508a-j arrayed around the room 502. Typically the loudspeakers are placed against respective walls of the room and some or all may be placed on the bottom, middle or top of the wall to provide height projection of the sound. The loudspeaker array thus provides a 3D sound scene in which audio objects can be perceived to move through the room based on which loudspeakers are playback the sound associated with the object. Audio object 506 is shown as having a particular trajectory that curves through the room. The arc direction and speed of the object are used by the renderer to derive the appropriate loudspeaker feeds so that this trajectory is most accurately represented for the audience. The initial location of loudspeakers in room 502 represents the nominal loudspeaker map for the room. The renderer determines which loudspeakers and the respective amount of gain to send to each loudspeaker that will play the sound associated with the object at any point in time. The loudspeaker map is deformed so that the loudspeaker feeds are biased to produce a deformed loudspeaker map, such as shown by the dashed region 510. Thus, for example, loudspeakers 508e and 508d may be used more heavily during the initial playback of sound for audio object 506, while loudspeakers 508i and 508j may be used more heavily during final playback of sound for audio object 506 with the remaining loudspeakers being used to a lesser extent while audio object 506 moves through the room.

Although embodiments are described with respect to trajectory based on velocity of an audio object or auditory source, it should be noted that the trajectory could be also or instead be based on the acceleration of the auditory source, the variance of the direction of the auditory source, or past and future values of the auditory source velocity.

In an embodiment the renderer thus begins with a nominal map defining loudspeaker locations in the listening environment. This can be defined in an AVR or cinema processor using known loudspeaker location definitions (e.g., left front, right front, center, etc.). The loudspeaker map is then deformed so as to modify the signals that are derived and reproduced over the loudspeakers. In particular, the loudspeaker map may be deformed using appropriate gain values sent to each of the loudspeakers so that the sound scene may effectively collapse in a given direction, such as shown in FIG. 5. The loudspeaker map may be updated at a specified rate corresponding to the frequency of gain values sent to each of the loudspeakers. This system provides a significant advantage over present systems that are based on present but not past or future locations of an auditory source. In many cases, the trajectory may change such that the closest loudspeakers are not optimum to track the longer-term trajectory of the object. The trajectory-based rendering process takes into account past and/or future location information to determine which loudspeakers and how much gain should be applied to all loudspeakers so that the audio trajectory of the object is recreated most efficiently by all of the available loudspeakers.

In an embodiment, audio object (auditory source) location is sent to the renderer at regular intervals, such as 100 times/second, or any other appropriate interval, at a time (e.g., 1/10 second) in the future. The renderer then determines how much gain to apply to each loudspeaker to accurately reproduce an instantaneous location of the object at that time. The frequency of the updates and the amount of time delay (look ahead) can be set by the renderer, or these may be parameters that can be set based on actual configuration and content requirements.

In an embodiment, a location-based renderer is used to determine the loudspeaker gains based on source location, the deformed loudspeaker map, and preferred panning laws. This may represent renderer 214 of FIG. 2, or part of this rendering component. Such a renderer is described in PCT Patent Publication WO-2013006330A2, entitled “System and Tools for Enhanced 3D Audio Authoring and Rendering,” which is assigned to the assignee of the present application. Other types of renderers may also be used, and embodiments described herein are not so limited. For example, the renderer may be VBAP [3], DBAP[7], MDAP [9], or any other panning law used to assign gains to loudspeakers based on the relative position of loudspeakers and a desired auditory source.

In an alternative embodiment, other features of the auditory source location may be computed such as auditory source acceleration, rate of change of auditory source velocity direction, or the variance of the auditory source velocity. In some systems, the audio program to be rendered may include auditory source velocity, or other parameters, as part of the sound scene description, in which case the velocity and/or other parameters need not be estimated at the time of playback. The map scaling may alternatively or additionally be determined by the auditory source acceleration, rate of chance of auditory source velocity direction, or the variance of the auditory source velocity.

Hence, a method 400 for rendering an audio program is described. The audio program may comprise one of: an audio file downloaded in its entirety to a playback processor including a renderer 214, and streaming digital audio content. The audio program comprises one or more audio objects 506, which are to be rendered as part of the audio program. Furthermore, the audio program may comprise one or more audio beds. The method 400 may comprise determining a nominal loudspeaker map representing a layout of loudspeakers 508 used for playback of the audio program. The loudspeakers 508 (i.e. the loudspeakers) may be arranged in a listening environment 502 such as a cinema. The loudspeakers 508 may be located within the listening environment 502 in accordance with the nominal loudspeaker map. As such, the nominal loudspeaker map may correspond to the physical layout of loudspeakers 508 within a listening environment 502.

The method 400 may further comprise determining 402 a trajectory of an audio object 506 of the audio program from and/or to a source location through 3D space. The audio object 506 may be positioned at a first time instant at the (current) source location. Furthermore, the audio object 506 may move away from the (current) source location through 3D space at later time instants according to the determined trajectory. As such, the trajectory may comprise or may indicate a direction of motion of the audio object 506 starting from the (current) source location. In particular, the trajectory may comprise or may indicate a difference of location of the audio object 506 at a first time instant and at a (subsequent) second time instant. In other word, the trajectory may indicate a sequence of different locations at a corresponding sequence of subsequent time instants.

The trajectory may be determined based at least in part on past, present, and/or future location values of the audio object 506. As such, the trajectory is indicative of the object location and of object change information. The future location values may be determined by one of: looking ahead in an audio tile containing the audio object 506, and using a latency factor created by a delay in playback of the audio program. The trajectory may further comprise or may further indicate a velocity or speed and/or an acceleration/deceleration of the audio object 506. The direction of motion, the velocity and/or the change of velocity of the trajectory may be determined based on the location values (which indicate the location of the audio object 506 within the 3D space, as a function of time).

The method 400 may further comprise deforming 404 the nominal loudspeaker map such that the map is scaled relative to the source location in the direction of motion of the audio object 506, to create an updated loudspeaker map. In other words, the nominal loudspeaker map may be scaled to move the loudspeakers 508 which are arranged to the left and to the right of the direction of motion of the audio object 506 closer to or further away from the audio object 506. A degree of scaling of the nominal loudspeaker map may depend on the velocity of the audio object 506. In particular, the degree of scaling may increase with increasing velocity of the audio object 506 or may decrease with decreasing velocity of the audio object 506. As such, the loudspeakers of the updated loudspeaker map may be moved towards the trajectory of the audio object 506, thereby moving the loudspeakers 508 into a collapsed region 510 around the trajectory of the audio object 506. The width of this region 510 perpendicular to the trajectory of the audio object 506 may decrease with increasing velocity of the audio object 506 (and vice versa). By making the degree of scaling dependent on the velocity of the audio object 506, the rendering of moving audio objects 506 may be improved further.

The step of deforming 404 the nominal loudspeaker map may comprise determining gain values for the loudspeakers 508 such that loudspeakers 508 along the direction of motion of the audio object 506 (i.e, to the left and right of the direction of motion) move closer to the source location and/or closer to the trajectory of the audio object 506. By determining such gain values for the loudspeakers 508, the loudspeakers 508 are mapped to a collapsed region 510 which follows the shape of the trajectory of the audio object 506. As such, the task of selecting two or more loudspeakers 508 for rendering sound that is associated with the audio object 506 is simplified. Furthermore, a smooth transition between selected loudspeakers 508 along the trajectory of the audio object 506 may be achieved, thereby enabling a consistent rendering of moving audio objects 506.

The method 400 may further comprise determining 406 loudspeaker gains for the loudspeakers 508 for rendering the audio object 506 based on the trajectory, based on the nominal loudspeaker map and based on a panning law, particular, the loudspeaker gains may be determined based on the updated loudspeaker map and based on a panning law (and possibly based on the source location). The panning law may be used for determining the loudspeaker gains for the loudspeakers 508 based on a relative position of the loudspeakers 508 in the updated loudspeaker map. Furthermore, the trajectory and/or the (current) source location may be taken into consideration by the panning law. By way of example, the two loudspeakers 508 in the updated loudspeaker map which are closest to the (current source location of the audio object 506 may be selected for rendering the sound associated with the audio object 506. The sound may then be panned between the two selected loudspeakers 508. As such, panning of audio objects 506 may be improved and simplified by deforming a nominal loudspeaker map based on the trajectory of the audio object 506. In particular, at each time instant (at which a panning law is to be applied, e.g. at a periodic rate), the two loudspeakers 508 from the updated (i.e. deformed) loudspeaker map which are closest to the current source location of the audio object 506 may be selected for panning the sound that is associated with the audio object 506. By doing this, a smooth and consistent rendering of moving audio objects 506 may be achieved.

In other words, a method 400 for rendering a moving audio object 506 of an audio program in a consistent manner is described. A trajectory of the audio object 506 starting from a current source location of the audio object 506 is determined. Furthermore, a nominal loudspeaker map is determined, which indicates the layout of loudspeakers 508 within a listening environment 502. The nominal loudspeaker map may be deformed based on the trajectory of the audio object 506 (i.e. based on the current, and past and/or future locations of the audio object). The nominal loudspeaker map may be deformed by scaling the nominal loudspeaker map relative to the source location in the direction of motion of the audio object 506. As a result of this, an updated loudspeaker map is obtained which follows the trajectory of the audio object 506. The loudspeaker gains for the loudspeakers 508 for rendering the audio object 506 may then be determined based on the updated loudspeaker map and based on a panning law (and possibly based on the source location).

As a result of using the updated loudspeaker map for determining the loudspeaker gains, panning of the sound associated with the audio object 506 is simplified. In particular, the selection of the appropriate loudspeakers 508 for rendering the sound associated with the audio object 506 along the trajectory is simplified, due to the fact that the loudspeakers 508 have been scaled to follow the trajectory of the audio object 506. This enables a smooth and consistent rendering of the sound associated with moving audio objects 506.

The method 400 may be applied to a plurality of different audio objects 506 of an audio program. Due to the different trajectories of the different audio objects 506, the nominal loudspeaker map is typically deformed differently for the different audio objects 506.

The method 400 may further comprise generating loudspeaker signals feeding the loudspeakers 508 (i.e. generating loudspeaker feeds) using the loudspeaker gains. In particular, the sound associated with the audio object 506 may be amplified / attenuated with the loudspeaker gains for the different loudspeakers 508, thereby generating the different loudspeaker signals for the different loudspeakers 508. As indicated above, this process may be repeated at a periodic rate (e.g. 100 times/second), in order to update the loudspeaker gains for the updated source location of the audio object 506. By doing this, the sound associated with the audio object 506 may be rendered smoothly along the trajectory of the moving audio object 506.

The method 400 may comprise encoding the trajectory as metadata defining e.g. instantaneous x, y, z position coordinates of the audio object 506, which are updated at the defined periodic rate. The method 400 may further comprise transmitting the metadata with the loudspeaker gains from a renderer 214.

The audio program may be part of audio/visual content and the direction of motion of the audio object 506 may be determined based on a visual representation of the audio object 506 comprised within the audio/visual content. As such, the trajectory of an audio object 506 may be determined to be consistent with the visual representation of the audio object 506.

Furthermore, a system for rendering an audio program is described. The system comprises a component for determining a nominal loudspeaker map representing a layout of loudspeakers 508 used for playback of the audio program. The system also comprises a component for determining a trajectory of an audio object 506 of the audio program from and/or to a source location through 3D space, wherein the trajectory comprises a direction of motion of the audio object 506 from and/or to the source location. In addition, the system may comprise a component for deforming the nominal loudspeaker map such that the map is scaled relative to the source location in the direction of motion of the audio object 506, to create an updated loudspeaker map. Furthermore, the system comprises a component for determining loudspeaker gains for the loudspeakers 508 for rendering the audio object 506 based on the source location, based on the updated loudspeaker map and based on a panning law. The panning law may determine the loudspeaker gains for the loudspeakers based on a relative position of the loudspeakers 508 in the updated loudspeaker map and the source location. The system may further comprise an encoder for encoding the trajectory as a trajectory description that includes a current instantaneous location of the audio object 506 as well as information on how the location of the audio object 506 changes with time.

### Metadata Definitions

In an embodiment, the immersive audio system includes components that generate metadata from an original spatial audio format. The methods and components of the described systems comprise an audio rendering system configured to process one or more bitstreams containing both conventional channel-based audio elements and audio object coding elements. The audio content thus comprises audio objects, channels, and position metadata. Metadata is generated in the audio workstation in response to the engineer's mixing inputs to provide rendering queues that control spatial parameters (e.g., position, velocity, intensity, timbre, etc. ) and specify which driver(s) or loudspeaker(s) in the listening environment play respective sounds during playback. The metadata is associated with the respective audio data in the workstation for packaging and transport by an audio processor.

In an embodiment, the audio type (i.e., channel or object-based audio) metadata definition is added to, encoded within, or otherwise associated with the metadata payload transmitted as part of the audio bitstream processed by an immersive audio processing system. In general, authoring and distribution systems for immersive audio create and deliver audio that allows playback via fixed loudspeaker locations (left channel, right channel, etc.) and object-based audio elements that have generalized 3D spatial information including position, size and velocity. The system provides useful information about the audio content through metadata that is paired with the audio essence by the content creator at the time of content creation/authoring. The metadata thus encodes detailed information about the attributes of audio that can be used during rendering. Such attributes may include content type (e.g., dialog, music, effect, Foley, background/ambience, etc.) as well as audio object information such as spatial attributes (e.g., 3D position, object size, velocity, etc.) and useful rendering information (e,g., snap to loudspeaker location, channel weights, gain, ramp, bass management information, etc.). The audio content and reproduction intent metadata can either be manually created by the content creator or created through the use of automatic, media intelligence algorithms that can be run in the background during the authoring process and be reviewed by the content creator during a final quality control phase if desired.

Many other metadata types may be defined by the audio processing framework. In general, a metadatum consists of an identifier, a payload size, an offset into the data buffer, and an optional payload. Many metadata types do not have any actual payload, and are purely informational. For instance, the “sequence start” and “sequence end” signaling metadata have no payload, as they are just signals without further information. The actual object audio metadata is carried in “Evolution” frames, and the metadata type for Evolution has a payload size equal to the size of the Evolution frame, which is not fixed and can change from frame to frame. The term Evolution frame generally refers to a secure, extensible metadata packaging and delivery framework in which a frame can contain one or more metadata payloads and associated timing and security information. Although embodiments are described with respect to Evolution frames, it should be noted that any appropriate frame configuration that provides similar capabilities may be used.

In an embodiment, the metadata conforms to a standard defined for the Dolby Atmos system. Such as format is defined in WD Standard, SMPTE 429- XX:20YY entitled “Immersive Audio Bitstream Specification.”

In an embodiment, the metadata packages includes location audio object location information in the form of the (x,y,z) coordinates as 16 bit scalar values, with updates corresponding to a rate of up to 192 times per second, where sb is a time index:
ObjectPosX [sb] . . . 16
ObjectPosY [sb] . . . 16
ObjectPosZ [sb] . . . 16

The velocity is computed based on current and past values as follows:

velocity[sb]=(ObjectPosX[sb]−ObjectPosX[sb−n])/n*x+(ObjectPosY[sb]−ObjectPosY[sb−n])n*y+(ObjectPosZ[sb]−ObjectPosZ[sb−n])/n*z

In the above expressions, n is the time interval over which to estimate the average velocity, and x,y,z are unit vectors in the location coordinate space.

Alternatively, by reading ahead in a file, or by introducing latency in a streaming application, the velocity can be computed over a time interval centered on the current time, sb:

velocity[sb]=sqrt((ObjectPosX[sb+n/2]−ObjectPosX[sb−n/2])/n*x+(ObjectPosY[sb+n/2]−ObjectPosY[sb−n/2])/n*y+(ObjectPosZ[sb+n/2]−ObjectPosZ[sb−n/2])/n*z

Embodiments have been described for a system that uses different loudspeakers in a listening environment to generate a different sound field (i.e., change the physical sound attributes), with the intention of having listeners perceive the sound scene exactly as described in the soundtrack by maintaining the perceived auditory attributes.

Although embodiments have been described with respect to digital audio signals and program transmission using digital bitstreams, it should be noted that the audio content and associated transfer function information may instead comprise analog signals. In this case, the transfer function can be encoded and defined, or a transfer function preset selected, using analog signals such as tones. Alternatively, for analog or digital programs, the target transfer function could be described using an audio signal; for example, a signal with flat frequency response (e.g. a tone sweep or pink noise) could be processed using a pre-emphasis filter so as to give a flat response when the desired transfer function (acting as a de-emphasis filter is applied.

Furthermore, although embodiments have been primarily described in relation to content and distribution for cinema (movie) applications, it should be noted that embodiments are not so limited. The playback environment may be a cinema or any other appropriate listening environment for any type of audio content, such as a home, room, car, small auditorium, outdoor venue, and so on.

Aspects of the methods and systems described herein may be implemented in an appropriate computer-based sound processing network environment for processing digital or digitized audio files. Portions of the immersive audio system may include one or more networks that comprise any desired number of individual machines, including one or more routers (not shown) that serve to buffer and route the data transmitted among the computers. Such a network may be built on various different network protocols, and may be the Internet, a Wide Area Network (WAN), a Local Area Network (LAN), or any combination thereof. In an embodiment in which the network comprises the Internet, one or more machines may be configured to access the Internet through web browser programs.

One or more of the components, blocks, processes or other functional components may be implemented through a computer program that controls execution of a processor-based computing device of the system. It should also be noted that the various functions disclosed herein may be described using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, physical (non-transitory), non-volatile storage media in various forms, such as optical, magnetic or semiconductor storage media.

Embodiments are further directed to systems and articles of manufacture that perform or embody processing commands that perform or implement the above-described method acts, such as those illustrated in the flowchart of FIG. 4.

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to,” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation on so as to encompass all such modifications and similar arrangements.

Various aspects of the present invention may be appreciated from the following enumerated example embodiments (EEEs).
EEE 1. A method of rendering an audio program, comprising:

defining a nominal loudspeaker map of loudspeakers used for playback of the audio program;

determining a trajectory of an auditory source corresponding to one or more audio objects through 3D space;

generating loudspeaker signals feeding the loudspeakers based on the one or more audio object trajectories; and
rendering the one or more audio objects based on object location to match the trajectory of the auditory source as perceived by a listener in the listening environment.
EEE 2. The method of EEE 1 wherein object location change information deforms the loudspeaker map to create one or more updated loudspeaker maps.
EEE 3. The method of any of EEEs 1 and 2 further comprising generating loudspeaker feeds to appropriate loudspeakers in the loudspeaker map so that optimal loudspeakers generate the audio signal in accordance with the trajectory, and wherein the gains applied to the one or more loudspeakers to bias playback of sound in the listening environment to match the apparent movement of the auditory source.
EEE 4. The method of any of EEEs 1 to 3 wherein the trajectory comprises a difference of location of the audio object at a first time and a second time.
EEE 5. The method of EEE 4 wherein at least one of a velocity or acceleration of the auditory source and is represented as a set of instantaneous speed and direction vectors updated at the defined periodic rate.
EEE 6. The method of EEE 5 wherein the trajectory comprises velocity based at least in part on past, present, and future location values of the auditory source.
EEE 7. The method of EEE 6 wherein the future location values are determined by one of: looking ahead in an audio file containing the audio object, and using a latency factor created by a delay in playback of the audio program.
EEE 8. The method of any of EEEs 1 to 7 further comprising encoding the trajectory as metadata defining instantaneous x, y, z position coordinates of the auditory source updated at the defined periodic rate.
EEE 9. The method of EEE 8 further comprising transmitting the metadata with the loudspeaker gains from a renderer to an array of loudspeakers in the listening environment, wherein the array of loudspeakers are located in accordance with the nominal loudspeaker map.
EEE 10. The method of any of EEEs 1-8 wherein the audio program is part of audio/visual content and the apparent movement is based on associated content comprising a. visual representation of the audio object.
EEE 11. The method of any of EEEs 1 to 10 wherein the audio program comprises one of: an audio file downloaded in its entirety to a playback processor including the renderer, and streaming digital audio content.
EEE 12. A method of rendering an audio program, comprising:

defining a loudspeaker map of loudspeakers used for playback in a listening environment;
determining an instantaneous location of an audio object at a first time;

determining a subsequent location of the audio object at a second time, the difference in location between the first time and second time defining a trajectory of the audio object through 3D space; and

using the trajectory to change loudspeaker feed signals to the loudspeakers by applying different loudspeaker gains to same or different sets of loudspeakers while maintaining perceived auditory attributes of the audio object.
EEE 13. The method of EEE 12 further comprising encoding the trajectory as a trajectory description that includes current instantaneous location as well as information on how the location changes with time.
EEE 14. The method of EEE 13 wherein the audio object is part of an audio program transmitted to a renderer as a digital bitstream, and wherein the encoded trajectory is transmitted as metadata encoded in the digital bitstream, and associated with gain values transmitted to loudspeakers in a listening environment.
EEE 15. The method of any of EEEs 12 to 14 wherein the second time represents a future time of playback of the audio program.
EEE 16. The method of EEE 15 wherein the audio program comprises an audio file downloaded in its entirety to a playback processor including the renderer.
EEE 17. The method of EEE 16 wherein determining the subsequent location of the object at the second time comprises looking ahead in the downloaded audio file by an appropriate time period.
EEE 18. The method of any of EEEs 12 to 17 wherein the audio program comprises streaming digital audio content.
EEE 19. The method of EEE 18 wherein determining the subsequent location of the object at the second time comprises delaying playback of the streaming digital audio content by an appropriate time period.
EEE 20. The method of any of EEEs 12 to 19 further comprising updating the subsequent location of the audio object by a specified time period comprising at least a fraction of a second.

EEE 21. A system for rendering an audio program, comprising:
a first component collecting or deriving dynamic trajectory parameters of each audio object in the audio program, wherein the parameters of the dynamic trajectory may be included explicitly in the audio program or may be derived from the instantaneous location of audio objects at two or more points in time;
a second component generating loudspeaker signals feeding the loudspeakers based on the one or more audio object trajectory parameters; and
a third component deriving one or more loudspeaker channel feeds based on the instantaneous audio object location, and the changed loudspeaker feeds.
EEE 22. The system of EEE 21 further comprising an encoder encoding the trajectory as a trajectory description that includes current instantaneous location as well as information on how the location changes with time, and wherein changed loudspeaker feeds deform a loudspeaker map comprising locations of loudspeakers based on the audio object trajectory parameters,
EEE 23. The system of EEE 22 wherein the audio object is part of an audio program transmitted to a renderer incorporating the first component, as a digital bitstream, and wherein the encoded trajectory is transmitted as metadata encoded in the digital bitstream, and associated with gain values transmitted to loudspeakers in a listening environment.
EEE 24. The system of any of EEEs 21 to 23 wherein the audio program comprises one of: an audio file downloaded in its entirety to a playback processor including the renderer, and streaming digital audio content.
EEE 25. The system of EEE 24 wherein the trajectory comprises velocity based at least in part on past, present, and future location values of the auditory source.
EEE 26. The system of EEE 25 wherein the future location values are determined by one of: looking ahead in an audio file containing the audio object, and using a latency factor created by a delay in playback of the audio program.
EEE 27. A method of rendering an audio program comprising:
generating one or more loudspeaker channel feeds based on a dynamic trajectory of each audio object in the audio program, wherein the parameters of the dynamic trajectory may be included explicitly in the audio program or may be derived from the instantaneous location of audio objects at two or more points in time; and
changing loudspeaker signals feeding the loudspeakers based on the one or more audio object trajectory parameters from first sets of loudspeakers to second sets of loudspeakers to correspond to the dynamic trajectory of the each audio object.
EEE 28. The method of EEE 27 wherein changing the loudspeaker feeds deforms a loudspeaker map comprising locations of loudspeakers receiving the one or more loudspeaker channel feeds.
EEE 29. The method of any of EEEs 27 to 28 wherein the trajectory comprises at least one of: a velocity of an audio object, an acceleration of an audio object, a variance in direction of an audio object, a past value of audio object velocity, and a future value of audio object velocity.

1. A method of rendering an audio program, comprising:
determining a nominal loudspeaker map representing a layout of loudspeakers used for playback of the audio program;
determining a trajectory of an audio object of the audio program from and/or to a source location through 3D space; wherein the trajectory indicates a direction of motion of the audio object from and/or to the source location;
deforming the nominal loudspeaker map based on the trajectory such that he map is scaled relative to the source location, to create an updated loudspeaker map; and
determining loudspeaker gains for the loudspeakers for rendering the audio object, based on the source location, based on the updated loudspeaker map and based on a panning law; wherein the panning law determines the loudspeaker gains for the loudspeakers based on a relative position of the loudspeakers in the updated loudspeaker map.

2. The method of claim 1, wherein the nominal loudspeaker map is determined such that the map is scaled relative to the source location in the direction of motion of the audio object, to create the updated loudspeaker map.

3. The method of claim 1 further comprising generating loudspeaker signals feeding the loudspeakers using the loudspeaker gains, for rendering sound associated with the audio object.

4. The method of claim wherein determining loudspeaker gains comprises selecting the one, two or more loudspeakers in the updated loudspeaker map being closest to the source location for rendering sound associated with the audio object,

5. The method of claim 1, wherein deforming the nominal loudspeaker map comprises determining gain values for the loudspeakers such that loudspeakers along the direction of motion of the audio object move closer to the source location.

6. The method of claim 1, wherein a degree of scaling of the nominal loudspeaker map depends on a velocity of the audio object.

7. The method of claim 1, wherein the trajectory comprises the current location of the audio object and one or more past and/or future object locations.

8. The method of claim 1, wherein at least one of a velocity or acceleration of the audio object is represented as a set of instantaneous speed and direction vectors at multiple time instants.

9. The method of claim 1, wherein the trajectory comprises velocity of the audio object; wherein the velocity is determined based at least in part on past, present and/or future location values of the audio object.

10. The method of claim 9, wherein the future location values are determined by one of: looking ahead in an audio file containing the audio object, and using a latency factor created by a delay in playback of the audio program.

11. The method of claim 1. further comprising encoding the trajectory as metadata defining instantaneous x, y, z position coordinates of the audio object updated at multiple time instants.

12. The method of claim 11 further comprising transmitting the metadata specifying the loudspeaker gains from a renderer instead or in addition to location metadata to the loudspeakers in a listening environment, wherein the loudspeakers are located in accordance with the nominal loudspeaker map.

13. The method of claim 1, wherein the audio program is part of audio/visual content and the direction of motion of the audio object is determined based on a visual representation of the audio object comprised within the audio/visual content.

14. The method of claim 1, wherein the audio program comprises one of: an audio file downloaded in its entirety to a playback processor including a renderer, and streaming digital audio content.

15. A system rendering an audio program, comprising:
a component for determining a nominal loudspeaker map representing a layout of loudspeakers used for playback of the audio program;
a component for determining a trajectory of an audio object of the audio program from and/or to a source location through 3D space; wherein the trajectory indicates a direction of motion of the audio object from and/or to the source location;
a component for deforming the nominal loudspeaker map based on the trajectory such that the map is scaled relative to the source location, to create an updated loudspeaker map; and
a component for determining loudspeaker gains for the loudspeakers for rendering the audio object based on the source location, based on the updated loudspeaker map and based on a panning law; wherein the panning law determines the loudspeaker gains for the loudspeakers based on a relative position of the loudspeakers in the updated loudspeaker map.

16. The system of claim 15 further comprising an encoder for encoding the trajectory as a trajectory description that includes a current instantaneous location of the audio object as well as information on how the location of the audio object changes with time.
